(19) United States
(12) Patent Application Publication
(10) Pub. No.: US 2012/0052820 A1
(43) Pub. Date: Mar. 1, 2012

(54) Mobile Electronic Device and Data Process System Utilizing the Same

(75) Inventors: Hsien-Chang Lin, Taipei Hsien (TW); Hsi-Chuan Chen, Taipei Hsien (TW)

(73) Assignee: ACER INCORPORATED, Taipei Hsien (TW)

(21) Appl. No.: 13/047,598

(22) Filed: Mar. 14, 2011

(30) Foreign Application Priority Data
Aug. 31, 2010 (TW) 99129216

(51) Int. Cl. H04B 1/38

(52) U.S. Cl. 455/90.2

(57) ABSTRACT

A portable electronic device switches between antennas in order to decrease specific absorption rate (SAR). When the portable electronic device performs wireless communication, a sensor detects a distance between an object under test and the portable electronic device. The sensor sends a message to a control circuit, and the control circuit switches to a different antenna to decrease SAR.

### CROSS REFERENCE TO RELATED APPLICATIONS

This Application claims priority of Taiwan Patent Application No. 099129216 filed on Aug. 31, 2010, the entirety of which is incorporated by reference herein.

### BACKGROUND OF THE INVENTION

1. Field of the Invention

The disclosure relates generally to a portable electronic device, and more particularly, relates to a portable electronic device for switching between different antennas according to the distance between an object and the portable electronic device.

2. Description of the Related Art

With the progress of mobile communication technology, portable electronic devices, for example, portable computers, mobile phones, multimedia players, and other hybrid functional portable electronic devices, have become more common. To satisfy the demand of users, portable electronic devices usually can perform wireless communication functions. Some functions cover a large wireless communication area, for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area, for example, using Wi-Fi, Bluetooth, and WiMAX (Worldwide Interoperability for Microwave Access) systems and using frequency bands of 3.5 GHz, 5.2 GHz, and 5.8 GHz.

However, current portable electronic devices can not prevent users from being exposed to electromagnetic waves. For example, when a wireless communication operation is performed, a mobile phone transmits electromagnetic waves which are near to the head of a user. Therefore, governments have formulated criterion as to how much electromagnetic waves is safe for a human body to absorb, such as specific absorption rate, SAR criterion. SAR is a measure of the rate at which energy is absorbed by the human body when exposed to a radio frequency (RF) electromagnetic field. It is defined as the power absorbed per mass of tissue and has units of watts per kilogram (W/kg). In Taiwan, the criterion of SAR is that it should be smaller than 2 W/kg.

Now, many famous manufacturers have developed tablet PCs. Because tablet PCs are usually used near a human body, they often fail to pass the SAR criterion. A key factor of SAR is Total Radiated Power, TRP, of antennas, and TRP is determined by antenna efficiency and RF conducting power. Some manufacturers add a detector to tablet PCs, and the detector reduces RF conducting power when a human body approaches thereto. Nevertheless, RF conducting power should be determined based on the distance between a tablet PC and a base station. Thus, the quality of wireless communication degrades, when RF conducting power is reduced due to a human body approaching the detector.

### BRIEF SUMMARY OF THE INVENTION

In one exemplary embodiment, the disclosure is directed to a portable electronic device, comprising: a first antenna; a second antenna; a detector, detecting a distance between the detector and an object, and generating a message according to the distance; and a control circuit, receiving the message, and selecting the first antenna or the second antenna to transmit or receive a signal according to the message.

In another exemplary embodiment, the disclosure is directed to a method for switching between antennas in a portable electronic device having a first antenna and a second antenna, comprising: detecting a distance from the portable electronic device; generating a message according to the distance; and selecting either the first antenna or the second antenna to transmit or receive a signal according to the message.

In one exemplary embodiment, the disclosure is directed to a portable electronic device, comprising: an active antenna, comprising a plurality of child antennas to transmit or receive a signal; a detector, detecting a distance between the active antenna and an object, and generating a message according to the distance; and a control circuit, receiving the message, and selecting a first child antenna or the second child antenna among the plurality of child antennas of the active antenna to transmit or receive a signal according to the message.

In another exemplary embodiment, the disclosure is directed to a portable electronic device, comprising: a plurality of antennas; a plurality of detectors, detecting a distance between each of the plurality of antennas and an object, and generating a message according to the distance; and a control circuit, receiving the message, and selecting one of the plurality of antennas to transmit or receive a signal according to the message.

### BRIEF DESCRIPTION OF DRAWINGS

The invention can be more fully understood by reading the subsequent detailed description and examples with references made to the accompanying drawings, wherein:

FIG. 1 is a diagram illustrating a portable electronic device according to an embodiment of the invention;

FIG. 2 is a diagram illustrating a portable electronic device according to an embodiment of the invention;

FIG. 3 is a flowchart illustrating a method for switching between antennas according to an embodiment of the invention;

FIG. 4 is a diagram illustrating a portable electronic device according to an embodiment of the invention;

FIG. 5 is a diagram illustrating a portable electronic device according to an embodiment of the invention.

### DETAILED DESCRIPTION OF THE INVENTION

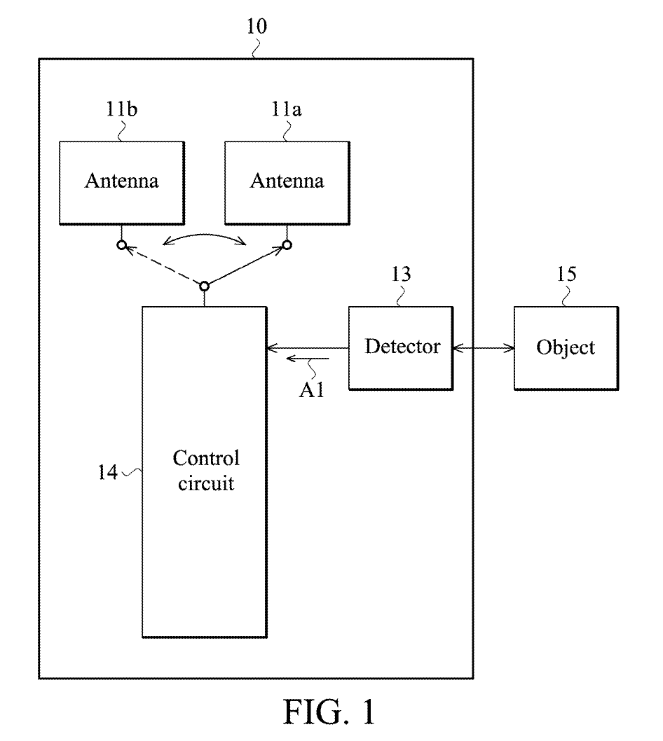

FIG. 1 is a diagram illustrating a portable electronic device 10 according to an embodiment of the invention. As shown in FIG. 1, the portable electronic device 10 comprises: an antenna 11a, an antenna 11b, a detector 13, and a control circuit 14. The portable electronic device 10 may be a mobile phone, a tablet PC, a personal digital assistant, PDA, a multimedia player, a game player, a GPS (Global Positioning System) navigation system, or other mobile electronic devices having wireless communication. Each of the antennas 11a and 11 b may be a planar inverted F antenna, a monopole antenna, a loop antenna, a helical antenna, a chip antenna, or other antenna that is suitable for the portable electronic device 10. The detector 13 may be an infrared detector, a light source detector, a pressure detector, a close detector, an ultrasonic detector, or other detectors that can detect the approach of human body. In an embodiment as shown in FIG. 1, being close to each other, the antenna 11a and the antenna 11b may have different antenna efficiencies, or different radiation patterns. Note that, FIG. 1 only illustrates important components related to the invention, other components like a signal source, or a central processing unit that is well-known for a skilled person in the art, are not discussed or shown. To begin, the control circuit 14 of the portable electronic device 10 uses the antenna 11a to wirelessly transmit or receive a signal. During the period, the detector 13 transmits a message A1 to the control circuit 14 when detecting that the distance between an object 15 under test and the detector 13 is smaller than or equal to a predetermined distance, such as 5 cm. The object 15 under test may be human body or matter. When receiving the message A1, the control circuit 14 switches to another antenna not in use, e.g., the control circuit 14 switches from the antenna 11a to the antenna 11b and uses the antenna 11b to transmit or receive a signal. The dashed line arrow and the solid line arrow in FIG. 1 represent the control circuit 14 switching from one antenna to another antenna. Although FIG. 1 uses a switch (the dashed and solid line arrows) to represent switching between different antennas, a solid switch is not essential, e.g., the control circuit 14 can use other known technology to transmit a signal and feed in an antenna. In the embodiment, the antenna 11b and the antenna 11a may have different radiation patterns, and preferably, the antenna 11b has a radiation pattern not toward the object 15. Even more preferable, the SAR of the portable electronic device 10 and the object 15 are able to decrease even if the RF conducting power remains unchanged. In addition, when the antenna 11b is in use, the detector 13 may transmit the message A1 to the control circuit 14 to switch to the antenna 11a on the condition that the detector 13 detects the object 15 far away from the detector 13.

In another embodiment, the antenna 11a has better antenna efficiency than the antenna 11b. Therefore, the portable electronic device 10 uses the antenna 11a to wirelessly transmit or receive a signal. During the period, the detector 13 transmits a message A1 to the control circuit 14 when detecting that the distance between an object 15 under test and the detector 13 is smaller than or equal to a predetermined distance. When receiving the message A1, the control circuit 14 switches to another antenna not in use, i.e., the control circuit 14 switches from the antenna 11a to the antenna 11b and uses the antenna 11b to transmit or receive a signal. In the embodiment, due to the antenna efficiency of the antenna 11b being poorer than the antenna efficiency of the antenna, the SAR of the portable electronic device 10 and the object 15 can decrease even if the RF conducting power remains unchanged. In addition, when the antenna 11b is in use, the detector 13 may transmit the message A1 to the control circuit 14 to switch to the antenna 11a on the condition that the detector 13 detects the object 15 far away from the detector 13.

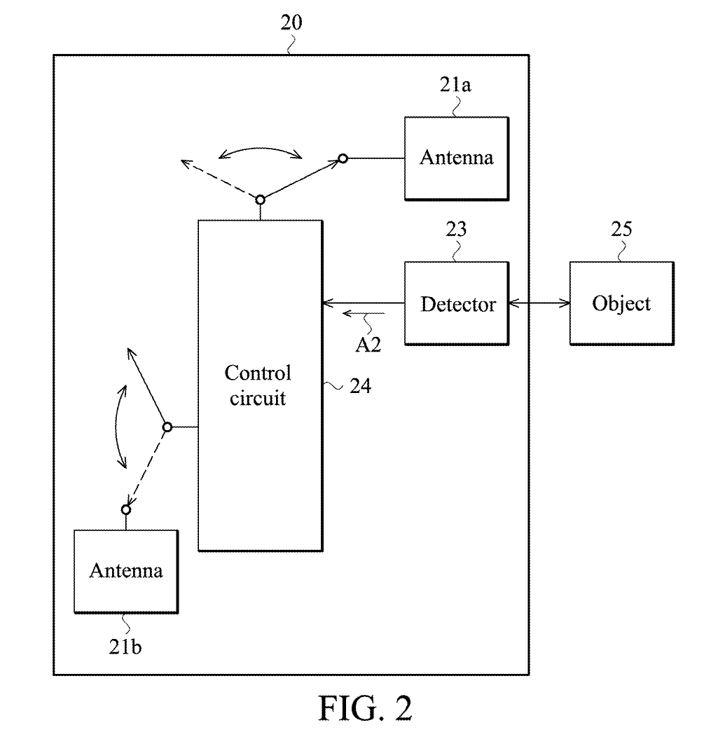

FIG. 2 is a diagram illustrating a portable electronic device 20 according to an embodiment of the invention. In the embodiment as shown in FIG. 2, an antenna 21a and an antenna 21b is located in different positions, and the distance between the antenna 21a and an object 15 is smaller than the distance between the antenna 21b and the object 15. A detector 23 may be located near the antenna 21a. Similarly, FIG. 2 only illustrates important components related to the invention, and other components are not discussed or shown. To begin, a control circuit 24 of the portable electronic device 20 may switch to the antenna 21a to wirelessly transmit or receive a signal. During the period, the detector 23 transmits a message A2 to the control circuit 24 when detecting that the distance between an object 25 under test and the detector 23 is smaller than or equal to a predetermined distance. When receiving the message A1, the control circuit 24 switches to another antenna not in use, e.g., the control circuit 24 switches from the antenna 21a to the antenna 21b and uses the antenna 21b to transmit or receive a signal. The SAR of the portable electronic device 20 and the object 25 can decrease even if the RF conducting power remains unchanged. In addition, when the antenna 21b is in use, the detector 23 may transmit the message A2 to the control circuit 24 to switch to the antenna 21a on the condition that the detector 23 detects that the object 25 is far away from the detector 23.

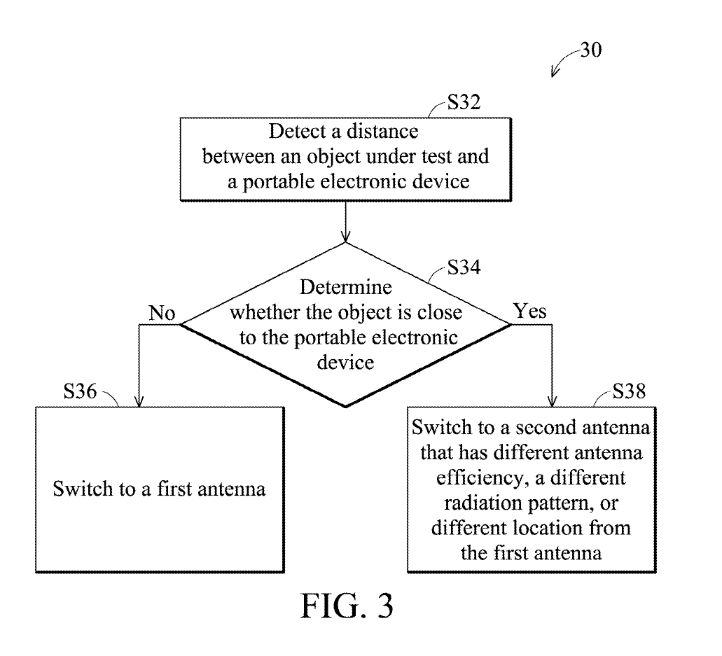

FIG. 3 is a flowchart 30 illustrating a method for switching between antennas according to an embodiment of the invention. FIG. 3 is applicable to a portable electronic device having a first antenna and a second antenna. The portable electronic device can switch to the first antenna or the second antenna to wirelessly transmit or receive a signal. The method comprises: first, detecting a distance between an object under test and the portable electronic device (S32) and generating a message according to the distance; second, if the object is far from the portable electronic device, i.e., the distance is larger than a predetermined distance (S34, No), the portable electronic device can switch to the first antenna (S36); if the object is close to the portable electronic device, i.e., the distance is smaller than or equal to the predetermined distance (S34, Yes), the portable electronic device can switch to the second antenna that has different antenna efficiency, a different radiation pattern, or different location from the first antenna (S38); and finally, the method ends.

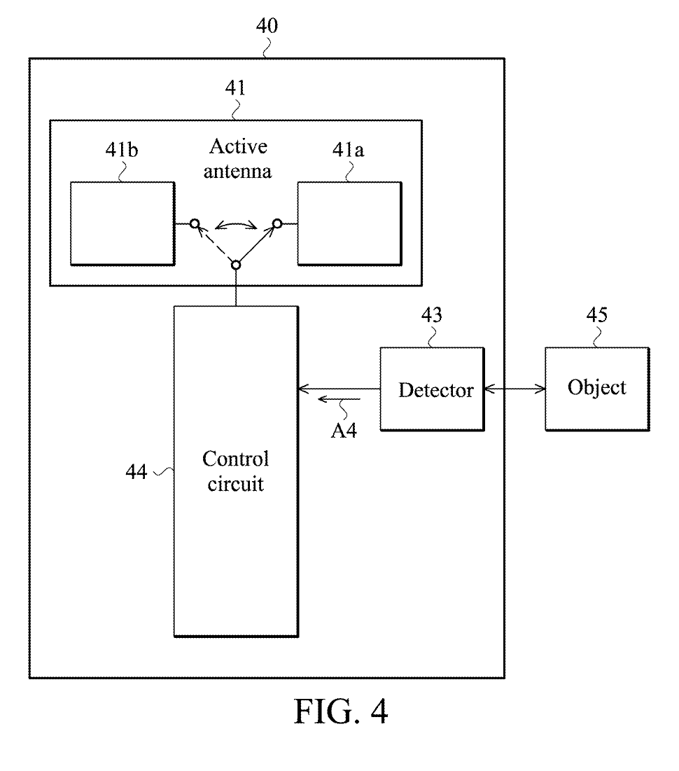

FIG. 4 is a diagram illustrating a portable electronic device 40 according to an embodiment of the invention. In the embodiment as shown in FIG. 4, an active antenna 40 comprises a plurality of child antennas, e.g., child antennas 41a and 41b. Although only two child antennas are shown in FIG. 4, the active antenna 40 may comprise more than 3 child antennas. The plurality of child antennas, e.g., child antennas 41a and 41b, may have different antenna efficiencies or different radiation patterns. Similarly, FIG. 4 only illustrates important components related to the invention, and other components are not discussed or shown. To begin, a control circuit 44 of the portable electronic device 40 may switch to the child antenna 41a of the active antenna 40 to wirelessly transmit or receive a signal. During the period, a detector 43 transmits a message A4 to the control circuit 44 when detecting that the distance between an object 45 under test and the detector 43 is smaller than a predetermined distance. When receiving the message A4, the control circuit 44 switches to another child antenna not in use, e.g., the control circuit 44 switches from the child antenna 41a to the child antenna 41b and uses the child antenna 41b to wirelessly transmit or receive a signal. The child antenna 41b may have antenna efficiency which is poorer than the child antenna 41a, or have a radiation pattern not toward the object 45. The SAR of the portable electronic device 40 and the object 45 can decrease even if the RF conducting power remains unchanged. In addition, when the child antenna 41b is in use, the detector 43 may transmit the message A4 to the control circuit 44 to switch to the child antenna 41a on the condition that the detector 43 detects that the object 45 is far away from the detector 43.

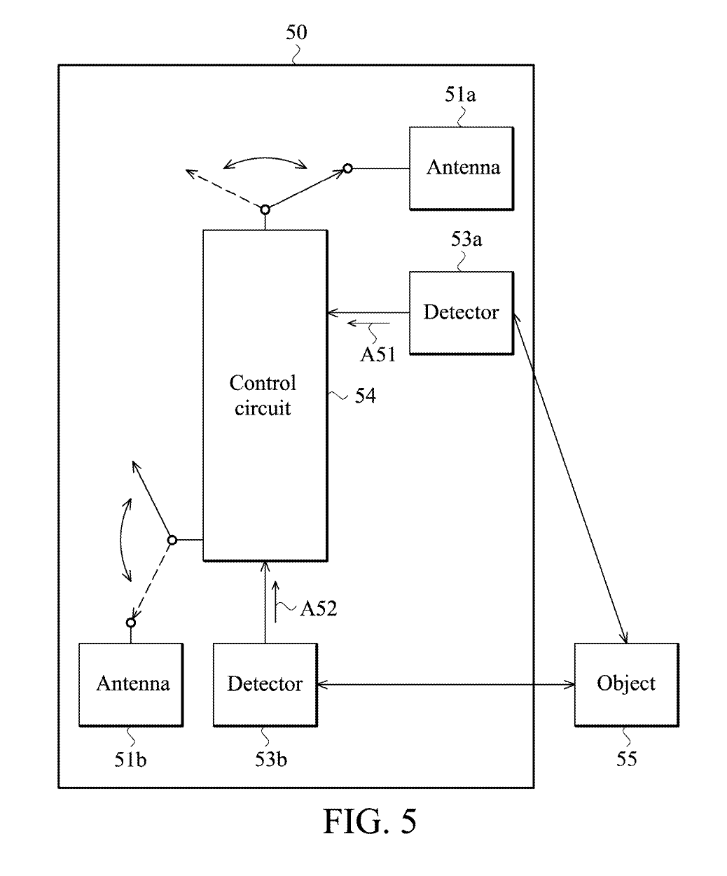

FIG. 5 is a diagram illustrating a portable electronic device 50 according to an embodiment of the invention. In the embodiment as shown in FIG. 5, the portable electronic device 50 comprises a plurality of antennas and a plurality of detectors. Although only two antennas and two detectors, i.e., antennas 51a, 51b, and detectors 53a, 53b, are shown in FIG. 5, the portable electronic device 50 may comprise more than 3 antennas and detectors. The antennas 51a and 51b may be put in different locations. The detectors 53a, 53b may be located near the antennas 51a, 51b, respectively. The antennas 51a and 51b may have different antenna efficiencies, or have different radiation patterns. Similarly, FIG. 5 only illustrates important components related to the invention, other components being not discussed or shown. To begin, the plurality of detectors detect the distances, each of which is between each of the plurality of antennas and an object, and then generate messages, e.g., the detector 53a detects the distance between the antenna 51a and the object 55, and the detector 53b detects the distance between the antenna 51b and the object 55. After then, the detectors 53a and 53b generate messages A51 and A52, respectively. The control circuit 54 receives the messages A1 and A2, and switches to one of the plurality of antennas which has the longest distance from the object 55, e.g., the control circuit 54 switches to the antenna 51a if the distance between the antenna 51a and the object 55 is larger than the distance between the antenna 51b and the object 55. On the contrary, the control circuit 54 switches to the antenna 51b if the distance between the antenna 51a and the object 55 is smaller than or equal to the distance between the antenna 51b and the object 55. The SAR of the portable electronic device 50 and the object 55 can decrease even if the RF conducting power remains unchanged.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A portable electronic device, comprising:
a first antenna;
a second antenna;
a detector, detecting a distance between the detector and an object, and generating a message according to the distance; and
a control circuit, receiving the message, and selecting the first antenna or the second antenna to transmit or receive a signal according to the message.

2. The portable electronic device as in claim 1, wherein the first antenna and the second antenna have different radiation patterns.

3. The portable electronic device as in claim 1, wherein the first antenna and the second antenna have different antenna efficiencies.

4. The portable electronic device as in claim 1, wherein the distance between the first antenna and the object is smaller than the distance between the second antenna and the object, wherein the control circuit selects the second antenna when the distance between the first antenna and the object is smaller than a predetermined distance, and the control circuit selects the first antenna when the distance between the first antenna and the object is larger than the predetermined distance.

5. The portable electronic device as in claim 1, wherein the first antenna and the second antenna have the same radio frequency radiation powers.

6. A method for switching between antennas in a portable electronic device having a first antenna and a second antenna, comprising:
detecting a distance from the portable electronic device;
generating a message according to the distance; and
selecting either the first antenna or the second antenna to transmit or receive a signal according to the message.

7. The method as in claim 6, wherein the first antenna and the second antenna have different radiation patterns.

8. The method as in claim 6, wherein the first antenna and the second antenna have different antenna efficiencies.

9. The method as in claim 6, wherein the distance between the first antenna and the object is smaller than the distance between the second antenna and the object, wherein the message indicates that the second antenna should be selected when the distance between the first antenna and the object is smaller than a predetermined distance, and the message indicates that the first antenna should be selected when the distance between the first antenna and the object is larger than the predetermined distance.

10. The method as in claim 6, wherein the first antenna and the second antenna have the same radio frequency radiation powers.

11. A portable electronic device, comprising:
an active antenna, comprising a plurality of child antennas to transmit or receive a signal;
a detector, detecting a distance between the active antenna and an object, and generating a message according to the distance; and
a control circuit, receiving the message, and selecting a first child antenna or the second child antenna among the plurality of child antennas of the active antenna to transmit or receive a signal according to the message.

12. The portable electronic device as in claim 11, wherein the first child antenna and the second child antenna have different radiation patterns.

13. The portable electronic device as in claim 11, wherein the first child antenna and the second child antenna have different antenna efficiencies.

14. The portable electronic device as in claim 11, wherein the first child antenna and the second child antenna have the same radio frequency radiation powers.

15. A portable electronic device, comprising:
a plurality of antennas;
a plurality of detectors, detecting distances, each of which is between each of the plurality of antennas and an object, and generating messages according to the distances; and
a control circuit, receiving the message, and selecting one of the plurality of antennas to transmit or receive a signal according to the message.

16. The portable electronic device as in claim 15, wherein the plurality of antennas have different radiation patterns.

17. The portable electronic device as in claim 15, wherein the plurality of antennas have different antenna efficiencies.

18. The portable electronic device as in claim 15, wherein the control circuit selects one of the plurality of antennas which has the longest distance from the object.

19. The portable electronic device as in claim 15, wherein the plurality of antennas have the same radio frequency radiation powers.
